(19) United States
(12) Patent Application Publication
(10) Pub. No.: US 2023/0351286 A1
(43) Pub. Date: Nov. 2, 2023

(54) PLANOGRAM INFORMATION GENERATION DEVICE AND PREDICTION MODEL

(71) Applicant: NTT DOCOMO, INC., Chiyoda-ku (JP)

(72) Inventor: Takaya TAMAKI, Chiyoda-ku (JP)

(73) Assignee: NTT DOCOMO, INC., Chiyoda-ku (JP)

(21) Appl. No.: 18/042,662

(22) PCT Filed: Aug. 18, 2021
(86) PCT No.: PCT/JP2021/030218

§ 371 Date: Feb. 23, 2023

(30) Foreign Application Priority Data
Aug. 27, 2020 (JP) 2020-143580

(51) Int. Cl. G06Q 10/0631; G06Q 10/087; G06Q 10/04; G06N 5/022

(52) U.S. Cl. CPC G06Q 10/06315; G06Q 10/087; G06Q 10/04; G06N 5/022

(57) ABSTRACT

A planogram information generation device (10) includes: a planogram condition/data acquisition unit (1001) serving as a planogram condition acquisition unit configured to acquire a planogram condition related to a store shelf for which planogram information is to be generated; a sales number prediction model inference unit (1003) serving as a sales number prediction unit configured to predict the number of future sales for each merchandise item on the basis of a machine learning model created on the basis of past purchase information on merchandise items; a display candidate merchandise item selection unit (1004) serving as a display candidate merchandise item selection unit configured to select a merchandise item that is a candidate for display on the basis of the past purchase information; a merchandise item grouping unit (1005) serving as a grouping unit configured to perform grouping of merchandise items capable of being placed on the store shelf; and a planogram merchandise item placement optimization unit (1006) serving as a planogram determination unit configured to generate the planogram information so that a predicted amount of sales of the merchandise items placed on the store shelf is maximized on the basis of the planogram condition, a result of sales number prediction for the merchandise items with a possibility of being placed on the store shelf, a result of selection of the display candidate merchandise item, and a result of grouping.

### TECHNICAL FIELD

The present disclosure relates to a planogram information generation device and a prediction model.

### BACKGROUND ART

In order to create a store shelf, a system is used to generate planogram information. For example, Patent Literature 1 discloses a method of registering a standard planogram pattern including a maximum planogram pattern with the largest sales floor size and a minimum planogram pattern with the smallest sales floor size in a group of stores, and generating a planogram pattern for stores excluding a store with the largest sales floor size and a store with the smallest sales floor size.

### CITATION LIST

### Patent Literature

[Patent Literature 1] Japanese Unexamined Patent Publication No. 2016-264754

### SUMMARY OF INVENTION

### Technical Problem

However, although the method disclosed in Patent Literature 1 is good for generating a plurality of planogram patterns for a plurality of store groups, there is still room for improvement in terms of increasing sales on specific shelves.

The present disclosure was contrived in view of the above problem, and an object thereof is to provide a technique that makes it possible to generate planogram information that can be expected to increase sales.

### Solution to Problem

In order to achieve the above object, according to an aspect of the present disclosure, there is provided a planogram information generation device configured to generate planogram information relating to merchandise item placement on a store shelf, the device including: a planogram condition acquisition unit configured to acquire a planogram condition related to a store shelf for which the planogram information is to be generated; a sales number prediction unit configured to predict the number of future sales for each merchandise item on the basis of a machine learning model created on the basis of past purchase information on merchandise items with a possibility of being placed on the store shelf; a display candidate merchandise item selection unit configured to select a merchandise item that is a candidate for display from the merchandise items with the possibility of being placed on the store shelf on the basis of the past purchase information on the merchandise items with the possibility of being placed on the store shelf; a grouping unit configured to perform grouping of merchandise items capable of being placed on the store shelf; and a planogram determination unit configured to generate the planogram information so that a predicted amount of sales of the merchandise items placed on the store shelf is maximized on the basis of the planogram condition, a result of sales number prediction for the merchandise items with the possibility of being placed on the store shelf, a result of selection of the display candidate merchandise item, and a result of grouping.

According to the above planogram information generation device, the number of future sales for each merchandise item is predicted on the basis of a machine learning model created on the basis of past purchase information on merchandise items with the possibility of being placed on the store shelf, and then the planogram information is generated so that the predicted amount of sales of the merchandise items placed on the store shelf is maximized on the basis of such sales number prediction as well. Therefore, it is possible to generate planogram information that can be expected to increase sales of the merchandise items placed on the store shelf.

### Advantageous Effects of Invention

According to the present disclosure, a technique that makes it possible to generate planogram information that can be expected to increase sales is provided.

### BRIEF DESCRIPTION OF DRAWINGS

FIG. 1 is a diagram illustrating a functional configuration of a planogram information generation system including a planogram information generation device according to an embodiment.

FIG. 2 is a diagram illustrating a configuration example of purchase information.

FIG. 3 is a diagram schematically illustrating a method of learning a sales number prediction model.

FIG. 4 is a diagram schematically illustrating a method of inferring the sales number prediction model.

FIG. 5 is a diagram illustrating a configuration example a merchandise item master.

FIG. 6 is a diagram illustrating an example of functional category information.

FIG. 7 is a diagram illustrating an example of grouping performed by a merchandise item grouping unit.

FIG. 8 is a diagram illustrating a configuration example of planogram information.

FIG. 9 is a configuration example of a store shelf to which a planogram merchandise item placement optimization unit is applied.

FIG. 10 is a diagram illustrating an example of category information which is used by the planogram merchandise item placement optimization unit.

FIG. 11 is a diagram illustrating an example of merchandise item category placement performed by the planogram merchandise item placement optimization unit.

FIG. 12 is a diagram illustrating an example of merchandise item placement performed by the planogram merchandise item placement optimization unit.

FIG. 13 is a diagram illustrating an example of display performed by a display unit.

FIG. 14 is a diagram illustrating another example of display performed by the display unit.

FIG. 15 is a diagram schematically illustrating an operation method performed by a correction unit.

FIG. 16 is a flowchart illustrating processing content of a planogram information generation method.

FIG. 17 is a diagram illustrating a configuration of a planogram information generation program.

FIG. 18 is a hardware block diagram of the planogram information generation device.

### DESCRIPTION OF EMBODIMENTS

An embodiment of the present disclosure will be described with reference to the accompanying drawings. The same components are denoted, if possible, by the same reference numerals and signs, and thus description thereof will not be repeated.

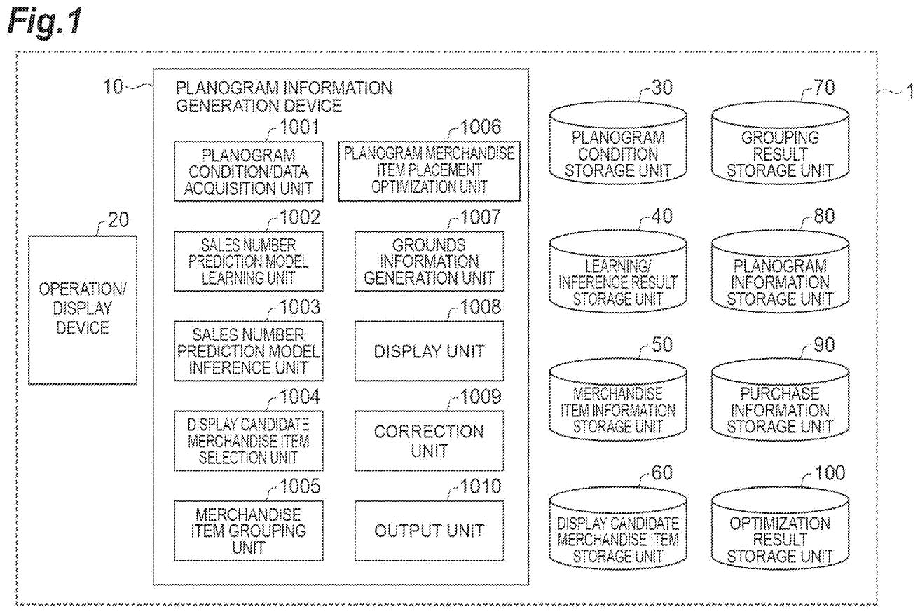

FIG. 1 is a diagram illustrating a functional configuration of a planogram information generation system 1 including a planogram information generation device 10 according to an embodiment. The planogram information generation device 10 is a device that automatically determines the placement of merchandise items and generates planogram information and grounds information so that the predicted amount of sales of merchandise items placed on a store shelf is maximized. Further, the planogram information generation device 10 includes a configuration for presenting the generated planogram information to a user to enable the user to confirm and correct the planogram information and the predicted amount of sales based on the planogram information.

As shown in FIG. 1, the planogram information generation system 1 includes the planogram information generation device 10, an operation/display device 20, a planogram condition storage unit 30, a learning/inference result storage unit 40, a merchandise item information storage unit 50, a display candidate merchandise item storage unit 60, a grouping result storage unit 70, a planogram information storage unit 80, a purchase information storage unit 90, and an optimization result storage unit 100.

The planogram information generation device 10 has a function of generating the above-described planogram information. The details of functions of the planogram information generation device 10, such as each functional unit constituting the planogram information generation device 10 and the generation of planogram information in the planogram information generation device 10, will be described later.

The operation/display device 20 is a device which is used by a user (planogram proposer) of the planogram information generation system 1. By the user operating the operation/display device 20, various types of information provided to the user are acquired in the operation/display device 20 and provided to the planogram information generation device 10. In addition, the operation/display device 20 displays the planogram information and the like generated and output by the planogram information generation device 10 to present them to the user. This enables the user to perform correction and the like on the generated planogram information. In this manner, the operation/display device 20 has a function of acquiring information, instructions, and the like provided from the user and providing them to the planogram information generation device 10 and a function of providing information output from the planogram information generation device 10 to the user.

The planogram condition storage unit 30, the learning/inference result storage unit 40, the merchandise item information storage unit 50, the display candidate merchandise item storage unit 60, the grouping result storage unit 70, the planogram information storage unit 80, the purchase information storage unit 90, and the optimization result storage unit 100 each have a function of holding various types of information used by the planogram information generation device 10. What kind of information and how each storage unit holds it will be described later.

The above planogram information generation system 1 may be configured as one device, or functions of the planogram information generation device 10, the operation/display device 20, the planogram condition storage unit 30, the learning/inference result storage unit 40, the merchandise item information storage unit 50, the display candidate merchandise item storage unit 60, the grouping result storage unit 70, the planogram information storage unit 80, the purchase information storage unit 90, and the optimization result storage unit 100 may be distributed in a plurality of devices. Further, the planogram information generation device 10 is configured to include a plurality of functional units, but each functional unit of the planogram information generation device 10 may be distributed in a plurality of devices.

As an example of the device configuration of the planogram information generation system 1, the operation/display device 20 may be configured as one terminal, and each functional unit other than the operation/display device 20 including the planogram information generation device 10 may be constituted by one server. In addition, as another example, the operation/display device 20 and one or a plurality of functional units out of the functional units constituting the planogram information generation device 10 may be configured as one device. In addition, the planogram condition storage unit 30, the learning/inference result storage unit 40, the merchandise item information storage unit 50, the display candidate merchandise item storage unit 60, the grouping result storage unit 70, the planogram information storage unit 80, the purchase information storage unit 90, and the optimization result storage unit 100 may be configured to be accessible from the planogram information generation device 10. Therefore, these storage units may be configured by any type of device.

In a case where the operation/display device 20 of the planogram information generation system 1 is configured as one terminal, for example, the user (planogram proposer) of the planogram information generation system 1 uses the operation/display device 20 to upload or input information and conditions necessary to generate the planogram information. The planogram information is created and output by the planogram information generation device 10 on the basis of the information acquired in the operation/display device 20. It is assumed that the user uses the operation/display device 20 to confirm whether the output planogram information is appropriate and correct it as necessary, thereby generating and acquiring final planogram information and information relating to the planogram information (for example, information relating to the predicted amount of sales or grounds information for determining a planogram).

A terminal constituting the operation/display device 20 or a terminal constituting the operation/display device 20 and some of the functional units of the planogram information generation device 10 is configured as an information processing terminal such as, for example, a PC, a high-performance cellular phone (smartphone), a cellular phone, or a tablet. In addition, one or more devices constituting the planogram information generation device 10 may each be constituted by, for example, a PC or the like.

Next, each functional unit of the planogram information generation device 10 will be described. As shown in FIG. 1, the planogram information generation device 10 is functionally configured to include a planogram condition/data acquisition unit 1001, a sales number prediction model learning unit 1002, a sales number prediction model inference unit 1003 (sales number prediction unit), a display candidate merchandise item selection unit 1004 (candidate merchandise item selection unit), a merchandise item grouping unit 1005 (grouping unit), a planogram merchandise item placement optimization unit 1006 (planogram determination unit), a grounds information generation unit 1007, a display unit 1008, a correction unit 1009, and an output unit 1010.

The planogram condition/data acquisition unit 1001 acquires conditions necessary to generate the planogram information and data for optimizing the planogram information so that the predicted amount of sales is maximized, which are input by the user in the operation/display device 20. The conditions necessary to generate the planogram information are assumed to be, for example, the length (width) of a planogram, the number of shelves, the number of stages, the ratio of manufacturers constituting merchandise item groups to be placed, fixed merchandise items desired to be positively to be placed, and the like for which the planogram information is to be generated. These conditions are stored in the planogram condition storage unit 30. In addition to the above information, any other conditions necessary to generate the planogram information may be acquired as needed.

Examples of data for optimizing the planogram information include a merchandise item master, planogram transfer specifications (PTS), point of sale system (POS) data, ID-POS, category data based on bundle purchase information, market POS data, and the like. The above examples of data for optimizing the planogram information are merely examples, and insofar as the data can be used to generate the planogram information for maximizing the predicted amount of sales, the type, format, and the like of the information are not particularly limited.

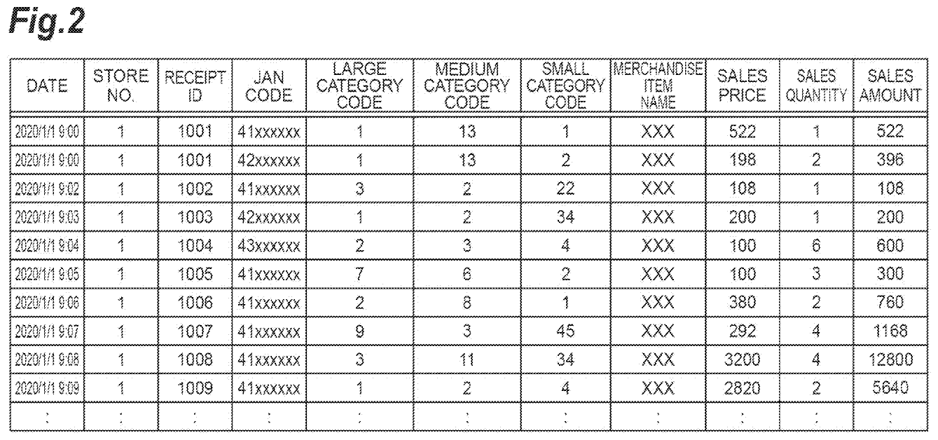

As an example of data for optimizing the planogram information, POS data/ID-POS data which is information relating to past purchase results of merchandise items is considered to be useful. FIG. 2 shows an example of POS data or ID-POS data. Purchase information may include a purchase date and time, information for specifying the purchased merchandise item, sales price, sales quantity, sales amount, and the like. Such merchandise item purchase information is stored in the purchase information storage unit 90. The merchandise item purchase information can be used to predict the number of sales when merchandise items are placed on a planogram.

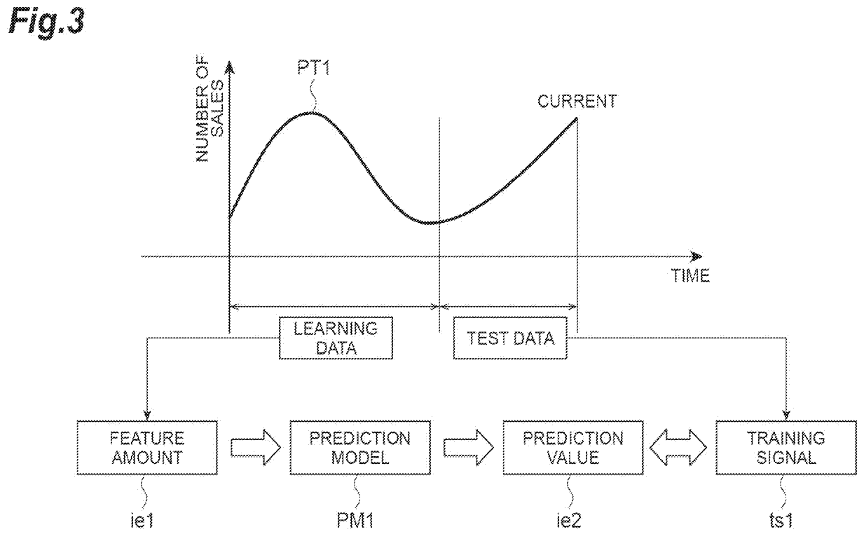

The sales number prediction model learning unit 1002 has a function of generating a model for predicting the number of sales of a specific merchandise item on the basis of the purchase information stored in the purchase information storage unit 90. FIG. 3 schematically shows a method of creating a model for predicting the number of sales of a specific merchandise item (sales number prediction model). As shown in FIG. 3, information on the number of past sales DT1 of a specific merchandise item is assumed to be obtained from the POS data or the like stored in the purchase information storage unit 90. In this case, a feature amount ie1 based on the number of sales for a specific interval (period) in the past in the information on the number of sales DT1 is used as an input (learning data) to create a prediction model PM1 for outputting a sales number feature amount ie2 for the next interval. That is, actual measurement data obtained in a period after the number of sales for a specific interval used as learning data is used as a training signal t1 to train the prediction model PM1 so that the evaluation of an evaluation formula r1 becomes higher.

Meanwhile, the feature amounts ie1 and ie2 of the number of sales used in the above description are information in which the relevance to merchandise item sales is reflected such as, for example, weekly or monthly averages or totals, and may be of any format insofar as it is appropriate for use in a predetermined learner.

In addition, as an example of learning evaluation in the prediction model PM1, for example, there is a method in which the total number of pieces of data constituting the information on the number of sales DT1 is set to N, P last data points are left to set the number of pieces of learning data to N-P, and test data to be used for evaluation is evaluated as a first point among the remaining P points (one point closest to the learning data). This evaluation is repeated P times to observe the generalization performance, which is assumed to be a method of performing learning evaluation in the prediction model PM1. This evaluation method is merely an example, and any method may be used insofar as it is an evaluation method for acquiring a model for universally predicting sales of a merchandise item or merchandise item category. After the prediction model PM1 is created by repeating learning so that the evaluation of the evaluation formula r1 becomes higher, the model is stored in the learning/inference result storage unit 40.

An example of a method of creating a model in the sales number prediction model learning unit 1002 will be described below. For example, an evaluation score in which the prediction model PM1 is used as a linear learner, the sales number feature amount ie1 is set to a time-series data group (yₜ₋ₜ, yₜ₋₂, . . . ) of the number of sales for a specific interval, the sales number feature amount for the next interval is set to ie2, the number of sales is set to yₜ, and the evaluation formula r1 is set to an Akaike information criterion (AIC) is defined as s. In this case, yₜ and s are calculated on the basis of the following Formulas (1) and (2).

$$[ Math . 1 ]$$

$$y \text{?} = \int ( \sum \text{?} w \text{?} y \text{?} )$$

$$[ Math . 2 ]$$

$$s = - 2 log ( L ( y \text{?} \vert w ) ) + 2 ( t - 1 )$$

$$\text{?} \text{indicates text missing or illegible when filed}$$

Here, the parameter w is used to weight the feature amount, and is a parameter obtained in advance by learning of a prediction model based on the feature amount. In addition, logL((yₜ|w)) indicates the logarithmic likelihood of the model based on a training signal ts1 based on actual measurement data. By obtaining the parameter w for which the above score s is minimized, it is possible to obtain a learning model for predicting the number of future sales.

The prediction model PM1 and the evaluation formula r1 are not limited to being constituted by a linear learner and AIC. The above configuration is an example, and any known technique can be adopted.

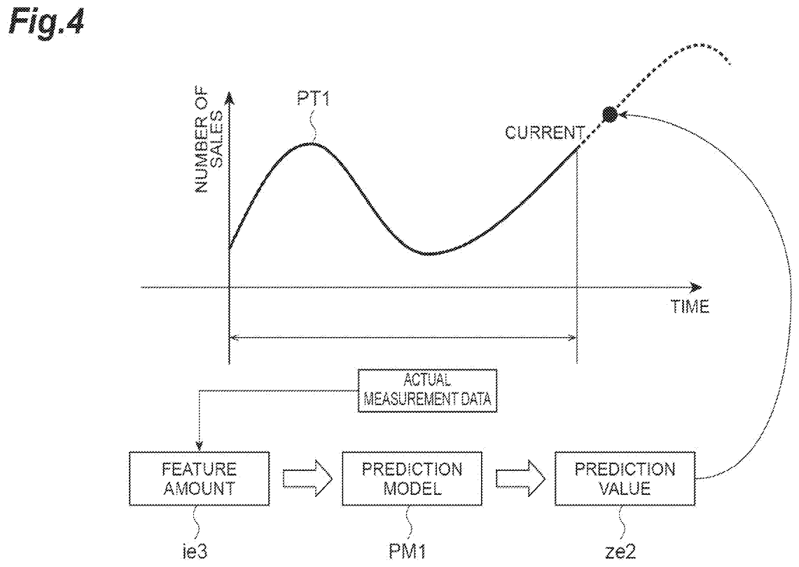

The sales number prediction model inference unit 1003 has a function of predicting the number of future sales of a specific merchandise item using the prediction model PM1 created by the sales number prediction model learning unit 1002 and stored in the learning/inference result storage unit 40. FIG. 4 is a diagram schematically illustrating a method of predicting the number of sales using the prediction model PM1. As shown in FIG. 4, the sales number prediction model inference unit 1003 inputs a sales number feature amount ie3 based on past actual measurement data DT2 to the prediction model PM1, and predicts a future sales number feature amount ze1 for which there is no observed data. As the sales number feature amount ie3 here, the same feature amount as the feature amount ie1 used in the sales number prediction model learning unit 1002 is selected.

An example of a method of predicting the number of sales in the sales number prediction model inference unit 1003 will be described below. For example, as an example of the present embodiment, outputting a future sales number data group (oₜ, oₜ₊₁, . . . ) with no observed data from the time-series data group (yₜ₋₁, yₜ₋₂, . . . ) of the number of past sales using a trained linear learner is considered. In this case, oₜ and oₜ₊₁ are calculated on the basis of the following Formulas (3) and (4), respectively.

$$\begin{matrix}[ Math . 3 ] & \\ {o}_{\text{?}} = f ( {\sum }_{\text{?}} {w}_{\text{?}} {o}_{\text{?}} ) & ( 3 )\end{matrix}$$

$$\begin{matrix}[ Math . 4 ] & \\ {o}_{\text{?}} = \int ( {\sum }_{\text{?}} {w}_{\text{?}} {o}_{\text{?}} ) & ( 4 )\end{matrix}$$

$$\text{?} \text{indicates text missing or illegible when filed}$$

According to the above formulas, in order to calculate oₜ₊₁, not only the past sales number data group (yₜ₋₁, yₜ₋₂, . . . ) but also the predicted of are used as input variables. In addition, when oₜ₊₂ is obtained, oₜ₊₁ is used as part of the input variables as in the calculation of oₜ₊₁. By repeating these steps, it is possible to predict the number of sales for any given period. Meanwhile, the above embodiment is merely an example, and any known technique can be adopted insofar as it is a technique for predicting the sales number feature amount. In addition, the model for predicting the number of sales used in the sales number prediction model learning unit 1002 and the sales number prediction model inference unit 1003 need only be at least a model for predicting the number of sales, and may be, for example, a model for calculating the amount of sales on the basis of the prediction.

The number of sales of each merchandise item is predicted through the functions of the sales number prediction model learning unit 1002 and the sales number prediction model inference unit 1003 described above.

The display candidate merchandise item selection unit 1004 performs various analyses such as an ABC analysis (priority analysis) for each item such as the number of sales or the amount of sales on the basis of store or market POS data (which may include ID-POS) stored in advance, and selects a merchandise item which is a candidate to be displayed on the store shelf. As an example, face increase or decrease and selection of a merchandise item to be added/cut may be performed. As described above, the store and market POS data (including ID-POS) is stored in the purchase information storage unit 90. The display candidate merchandise item selection unit 1004 uses the purchase information stored in the purchase information storage unit 90 to select a merchandise item that is a candidate to be displayed on the store shelf. Meanwhile, the method of selecting a merchandise item is not limited to the ABC analysis. The above embodiment is merely an example, and any known technique can be adopted. The selected result is stored in the display candidate merchandise item storage unit 60.

The merchandise item grouping unit 1005 performs grouping of merchandise items in order to determine from which merchandise item group the planogram merchandise item placement optimization unit 1006 to be described later preferentially calculates the optimization of merchandise item placement. Specifically, each merchandise item is grouped using category information included in the merchandise item master, attribute category information based on the feature of a merchandise item such as type, volume, or flavor, and functional category information of a merchandise item based on store or market bundle purchase information.

The merchandise item master category information, the merchandise item attribute category information, and the functional category information described above are stored in advance in the merchandise item information storage unit 50. In addition, the store purchase information is stored in advance in the purchase information storage unit 90. In addition, the results of grouping generated by the merchandise item grouping unit 1005 are stored in the grouping result storage unit 70.

Meanwhile, the functional category information based on the store purchase information is classified on the basis of the function of a merchandise item that can influence the number of sales of the merchandise item such as consumer purchasing factors regardless of the merchandise item manufacturer or the like. As a method of acquiring the functional category information from the purchase information, a method such as a category decision tree (CDT) analysis for constructing a system diagram of consumer purchase decision factors is assumed. The clustering method is not limited to the CDT analysis, and any known technique can be adopted insofar as it is a method for obtaining consumer purchase decision factors.

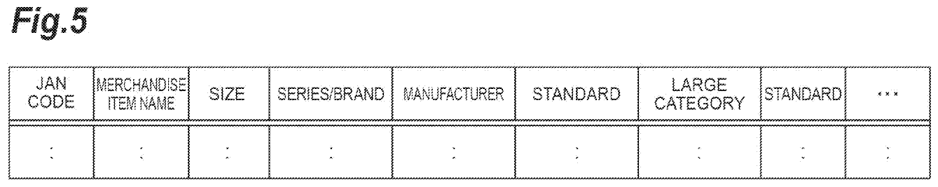

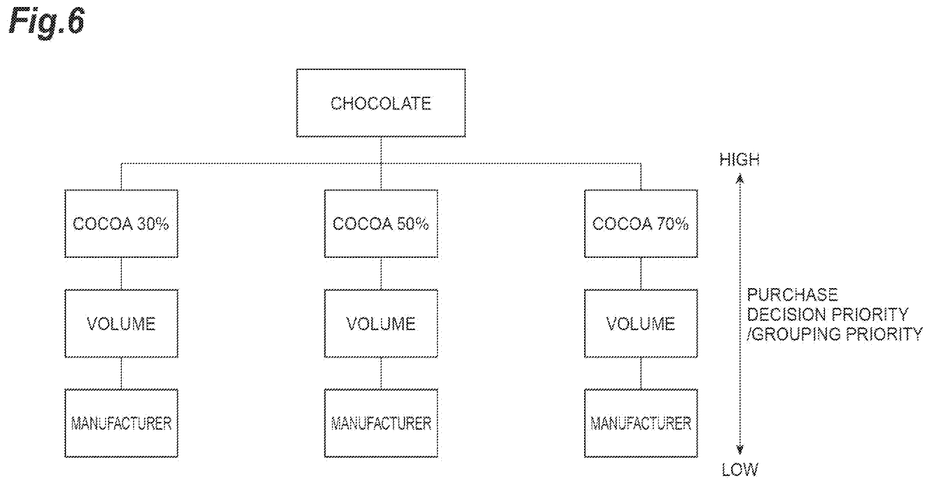

As an example of a method of performing grouping, dividing or integrating merchandise item groups in accordance with a defined priority on the basis of the series/brand item and functional category information of the category information of the merchandise item master labeled on each merchandise item can be considered. FIG. 5 shows an example of a format of the merchandise item master including attribute category information of a merchandise item, and FIG. 6 shows an example of a format of the functional category information.

As shown in FIG. 5, the merchandise item master includes information such as size, series/brand, manufacturer (manufacturer or distributor), standard, and the like in association with the merchandise item name. In addition, FIG. 6 shows an example in which chocolate is classified using functional categories. Examples of the type of functional category of chocolate include “cocoa content,” “volume,” “manufacturer,” and the like. FIG. 6 shows a state in which these multiple types of categories are arranged so that those with higher purchase decision priority or grouping priority become higher.

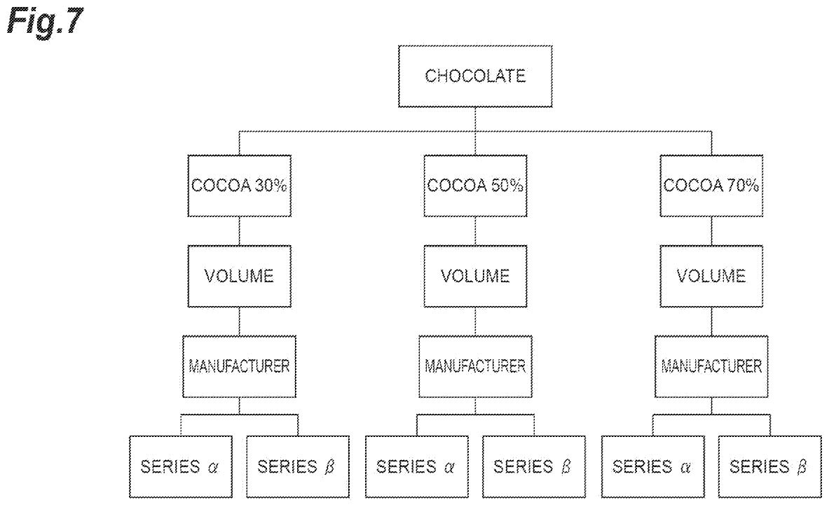

Assuming that the information shown in FIG. 5 and the information shown in FIG. 6 are combined and the priority is determined so that the functional category information and the merchandise item master category information are branched and integrated in this order, as shown in FIG. 7, the result of grouping is generated by further re-dividing the merchandise item groups divided by the functional category information by the attribute category information. The example shown in FIG. 7 is an example. The priority of grouping (which category is to be prioritized for classification) differs depending on the user.

Therefore, even for merchandise items of the same types, the structure of the result of grouping can take any form depending on the user. Meanwhile, information relating to the priority of grouping may be included in, for example, conditions necessary to generate the planogram information stored in the planogram condition storage unit 30.

The planogram merchandise item placement optimization unit 1006 performs final determination of display merchandise items and merchandise item placement using an optimization algorithm OA1 in order to maximize the amount of sales in the display candidate merchandise item group obtained by the display candidate merchandise item selection unit 1004, and outputs planogram information ptl and the predicted amount of sales es1. The optimization algorithm OA′ is an algorithm for determining and placing display merchandise items so that the predicted amount of sales is maximized. For example, an algorithm for solving an optimization problem related to discrete variables such as mixed integer programming can be used.

Main input data of the optimization algorithm OA1 is assumed to be planogram conditions (conditions necessary to generate planogram information), sales number prediction results, merchandise item masters, merchandise item grouping results, planogram transfer specifications (PTS), POS data, and the like. The planogram conditions, the sales number prediction results (results calculated using a prediction model), the merchandise item masters, the merchandise item grouping results, and the purchase information which are used in the planogram merchandise item placement optimization unit 1006 are stored in advance in the planogram condition storage unit 30, the learning/inference result storage unit 40, the merchandise item information storage unit 50, the display candidate merchandise item storage unit 60, the grouping result storage unit 70, and the purchase information storage unit 90 as described above. Among the information, information other than the sales number prediction results (results calculated using a prediction model) and the merchandise item grouping results which are obtained as a result of processing in the planogram information generation device 10 is stored in each unit by the processing of the planogram condition/data acquisition unit 1001.

At least a portion of various types of information listed above is used as input data to be input to the optimization algorithm OA1 here. In addition, the input data may be configured by combining information different from the information listed above. The planogram information ptl and the predicted amount of sales es1 which are optimization results are stored in the optimization result storage unit 100.

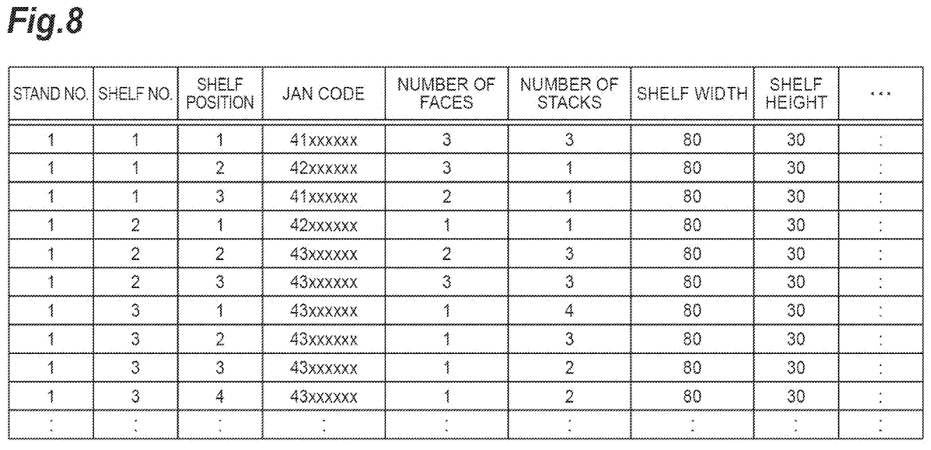

An example of a procedure of optimization based on the optimization algorithm OA1 will be described below. FIG. 8 is planogram information before optimization and is information indicating a state in which the merchandise item groups that are candidates for display stored in the display candidate merchandise item storage unit 60 are displayed in a row. Planogram information after optimization is generated by applying the optimization algorithm OA′ to this planogram information.

For example, the mixed integer programming is assumed to be adopted in the optimization algorithm OA1 on the basis of the planogram information shown in FIG. 8. In this case, when the sales price of a merchandise item i obtained from the purchase information storage unit 90 is set to pi and the predicted number of sales of the merchandise item i obtained from the learning/inference result storage unit 40 is set to βᵢ among the merchandise item groups that are candidates for display stored in the display candidate merchandise item storage unit 60, an objective function Z for maximizing the amount of sales is formulated as in the following Formula (5).

In addition, the number of merchandise items i lined up on the shelf k of the gondola o (stand o) is set to W_{iokf}, and the adjacency determination indicating the presence or absence of the adjacency between merchandise items of a category in and merchandise items of a category n on the shelf k of the gondola o shown in the following Formula (6) is set to Tₘₙₒₖ. By obtaining the number W_{iokf} and the adjacency determination Tₘₙₒₖ, it is possible to determine the merchandise item placement in the gondola for maximizing the amount of sales.

$$\begin{matrix}[ Math . 5 ] & \\ Z = \text{?} & ( 5 )\end{matrix}$$

$$\begin{matrix}[ Math . 6 ] & \\ \text{?} = ∈ \{ 0 , 1 \} & ( 6 )\end{matrix}$$

$$\text{?} \text{indicates text missing or illegible when filed}$$

Here, γₖ in Formula (5) is the weighting of the shelf k, and W_{iokf} indicates the number of faces of the merchandise item category or the merchandise item i on the shelf k in the gondola o. The reason why weighting is performed for each shelf is that sales according to the shelf position differ for each merchandise item. For example, generally, the shelf position at a height of approximately 85 cm to 150 cm where merchandise items are most visible and easy to pick up is called a golden zone, whereas the shelf position at a lower height is called a child zone. For example, in the department of sweets or the like, merchandise items which are likely to attract children's attention are placed in the child zone, while in the department of general food, the gold zone is more likely to contribute to sales than the child zone. This is because the height of the shelf position related to sales differs for each merchandise item.

In addition, the objective function Z obtained in Formula (5) described above is a multiplication of the sales price, the number of faces, and the predicted number of sales per merchandise item, and indicates the predicted amount of sales of all merchandise items. Adjacency determination based on Tₘₙₖ may be performed using a value (0 or 1) which is expressed by one bit, may be performed using a Boolean value (true or false), or may be performed by comparison of numerical values (for example, comparison thereof with a predetermined value). In this way, various methods can be used for the adjacency determination.

In addition, a case where the number of faces W_{iokf} is 0 means that the merchandise item is cut, and the optimization process here has a final merchandise item selection function considering sales such as face-up, face-down, and cut.

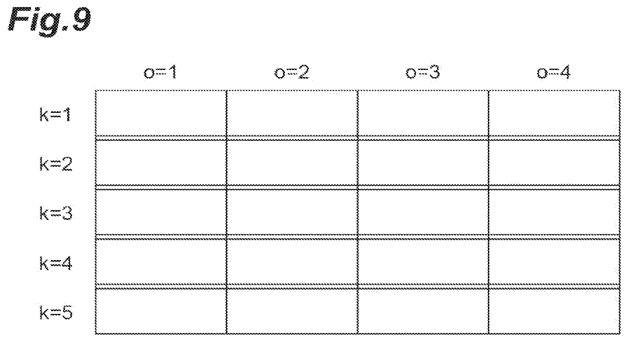

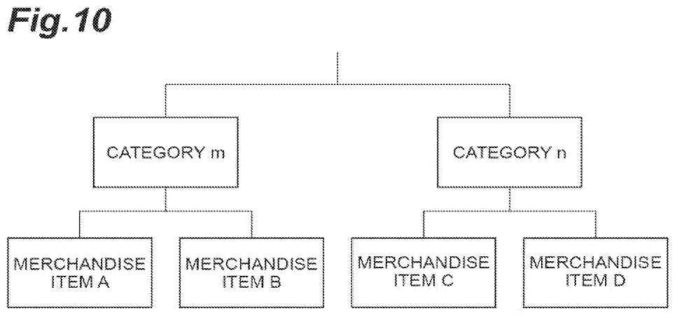

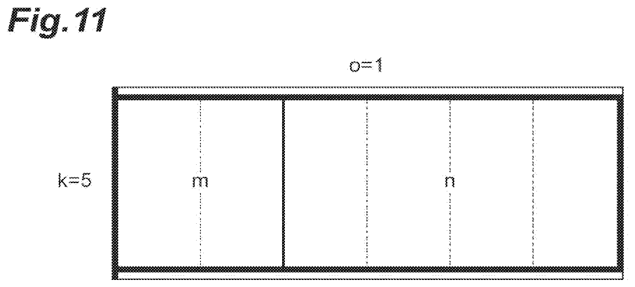

As an example of the present embodiment, for example, the gondolas o=1 to 4 obtained from planogram information of four patterns as shown in FIG. 9 are assumed. Each gondola is assumed to have five shelves of the shelves k=1 to 5. In addition, it is assumed that the results of grouping merchandise items A to D in the display candidate merchandise item group stored in the display candidate merchandise item storage unit 60 are as shown in FIG. 10. Specifically, it is assumed that the merchandise item A and the merchandise item B are grouped as the category in, and that the merchandise item C and the merchandise item D are grouped as the category n. Here, it is assumed that, through the optimization process, the number W_{15mf} of the category in lined up on the shelf k=5 of the gondola o=1 is W_{15mf}=2, the number W_{15nf} of the category n lined up is W_{15mf}=4, and the result of determination as to whether the category in is to the left of the category n is obtained as Tₙₘ₅=1. In this case, on the shelf k=5, it is determined that merchandise items of the category in and merchandise items of the category n are placed with the category m on the left with the number of faces of 2 and the category n on the right with the number of faces of 4 as shown in FIG. 11. In this way, how to place merchandise items of each category is determined through the optimization process.

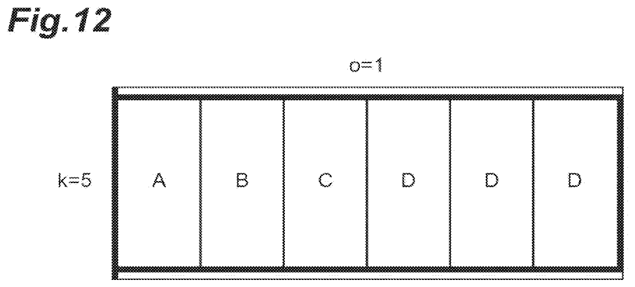

In addition, a merchandise item unit can also be considered in the same way. Here, it is assumed that the number of merchandise items A lined up on the shelf k=5 of the gondola o=1 is W_{15Af}=1, the number of merchandise items B lined up is W_{15Bf}=1, and the result of determination as to whether the merchandise item A is to the left of the merchandise item B is obtained as T_{AB5}=1 through the optimization process. In this case, the placement of merchandise items in the category m is determined as shown in FIG. 12. Further, when it is assumed that the number of merchandise items C lined up on the shelf k=5 of the gondola o=1 is W_{15Cf}=1, the number of merchandise items D lined up is W_{15Df}=3, and the result of determination as to whether the merchandise item C is to the left of the merchandise item D is obtained as T_{CD5}=1 through the optimization process, the placement of merchandise items in the category n is also determined as shown in FIG. 12.

In addition, it is also possible for the user to adjust the merchandise item category or merchandise item placement ratio, for example, by providing constraint formulas such as Formulas (7) and (8) during the optimization process on the basis of the planogram conditions stored in the planogram condition storage unit 30 in the optimization process.

$$\begin{matrix}[ Math . 7 ] & \\ \text{?} & ( 7 )\end{matrix}$$

$$\begin{matrix}[ Math . 8 ] & \\ \text{?} & ( 8 )\end{matrix}$$

$$\text{?} \text{indicates text missing or illegible when filed}$$

Here, uᵢ is the upper limit of placement of merchandise items or merchandise item category given by the planogram condition, and lᵢ is the lower limit of placement thereof.

Further, the value of the objective function Z shown in Formula (5) obtained through the placement optimization process indicates the prediction value of the amount of sales in the gondola considering the sales price of the display merchandise items and the predicted number of sales. Therefore, the user can know how much sales can be expected from the generated planogram information.

The above embodiment is merely an example, and any optimization algorithm including a combination of input data and constraint formulas may be used insofar as it is a method of determining merchandise item placement in order to maximize the amount of sales of all merchandise items in the gondola and outputting the prediction value of the amount of sales.

The grounds information generation unit 1007 collects the processing results of the sales number prediction model learning unit 1002, the sales number prediction model inference unit 1003, the display candidate merchandise item selection unit 1004, the merchandise item grouping unit 1005, and the planogram merchandise item placement optimization unit 1006, and outputs the grounds of merchandise item selection or the grounds of placement in the generated planogram as information. As the grounds information, specifically, for example, in the case of grounds information for merchandise item selection, the ranking of ABC analysis based on the number of sales in a store or market and the amount of sales and a list of merchandise items selected/cut actually are output. The above example is merely an example, and any method or technique can be used insofar as it is a method for the user to know the grounds of processing of each unit.

The display unit 1008 causes the operation/display device 20 to display the result of prediction of the number of sales performed by the sales number prediction model inference unit 1003, display candidate merchandise items selected by the display candidate merchandise item selection unit 1004, the result of grouping performed by the merchandise item grouping unit 1005, planogram information and the predicted amount of sales generated by the planogram merchandise item placement optimization unit 1006, and the processing result of each unit such as the grounds information generated by the grounds information generation unit 1007. Meanwhile, this is not an essential configuration in the planogram information generation device 10 of the present embodiment.

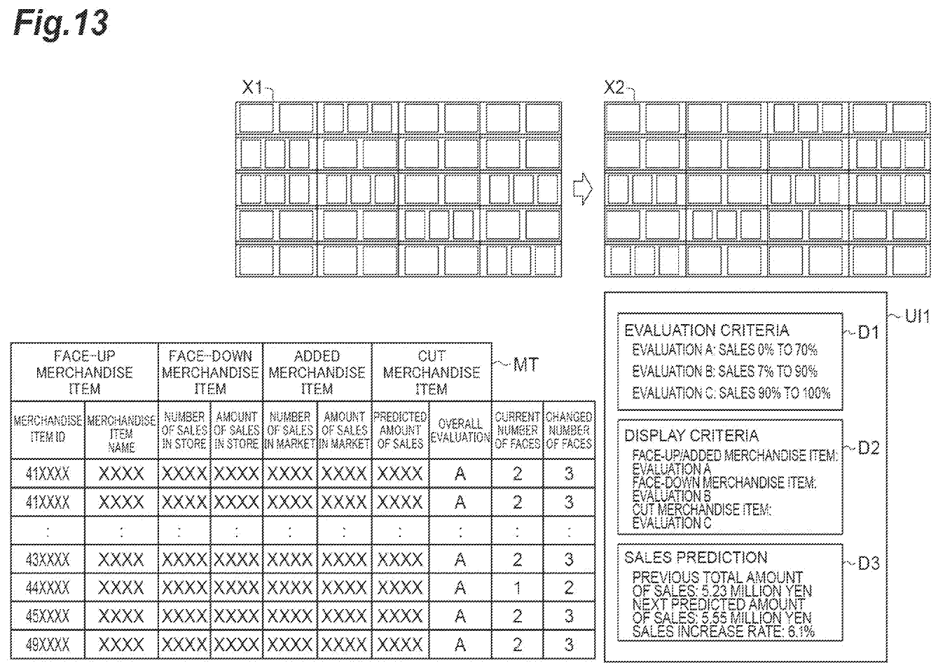

FIG. 13 is a diagram illustrating an example of display of information relating to the generated planogram. The display unit 1008 associates the predicted amount of sales based on the planogram information generated by the planogram merchandise item placement optimization unit 1006 with the results of priority analysis performed by the display candidate merchandise item selection unit 1004, and displays them in a predetermined aspect. The example shown in FIG. 13 is an example of output to the screen of the operation/display device 20 or the like.

As shown in FIG. 13, the display unit 1008 causes the operation/display device 20 to display a previous planogram X1 (previous planogram information) and a generated planogram X2 (planogram information created in the current process). Further, the display unit 1008 causes the operation/display device 20 to display priority analysis results MT of the display candidate merchandise item selection unit 1004 and information UI1 relating to the criteria for merchandise item placement.

The information UI1 is, for example, information relating to the conditions and the like of generated planogram information such as evaluation criteria D1, display criteria D2, and sales prediction results D3 for face increase or decrease and selection of a merchandise item to be added/cut. The information is associated with the previous planogram X1 and the generated planogram X2.

The example shown in FIG. 13 indicates that the amount of sales of the planogram X2 generated as the sales prediction results D3 increases more than the previous planogram. In addition, information relating to specific face-up/added merchandise items, face-down merchandise items, and cut merchandise items at that time is presented to the user as the final merchandise item selection results MT based on the optimization algorithm OA1 together with the evaluation criteria D1 and the display criteria D2.

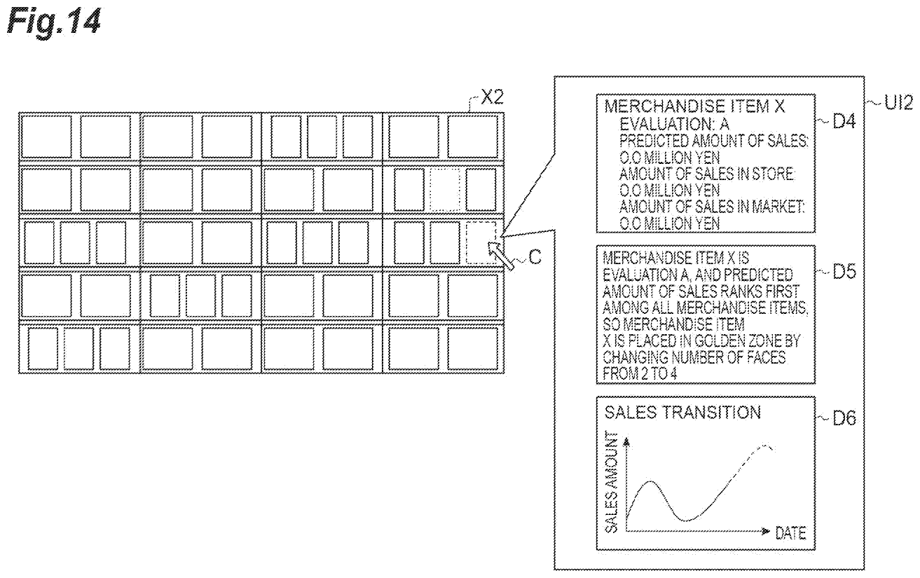

FIG. 14 is a diagram illustrating another example of display of information relating to the generated planogram. The display unit 1008 causes the operation/display device 20 to display the planogram X2 generated by the planogram merchandise item placement optimization unit 1006, and causes the operation/display device 20 to display grounds information UI2 of planogram placement in association therewith.

In the example shown in FIG. 14, specifically, it is assumed that the user clicks the placed merchandise item with a cursor C of the operation/display device 20. In this case, when the user clicks a specific merchandise item with the cursor C, the user can know what kind of information the selected merchandise item is based on to be placed at that position. Examples of the grounds information are assumed to include merchandise item sales information D4, placement reason D5, sales transition D6, and the like.

The above example is merely an example, and any method or a combination of results can be adopted insofar as it is a method for allowing the user to know the processing result of each unit.

The correction unit 1009 allows the user to perform placement correction or planogram condition change on the basis of the planogram information displayed by the display unit 1008.

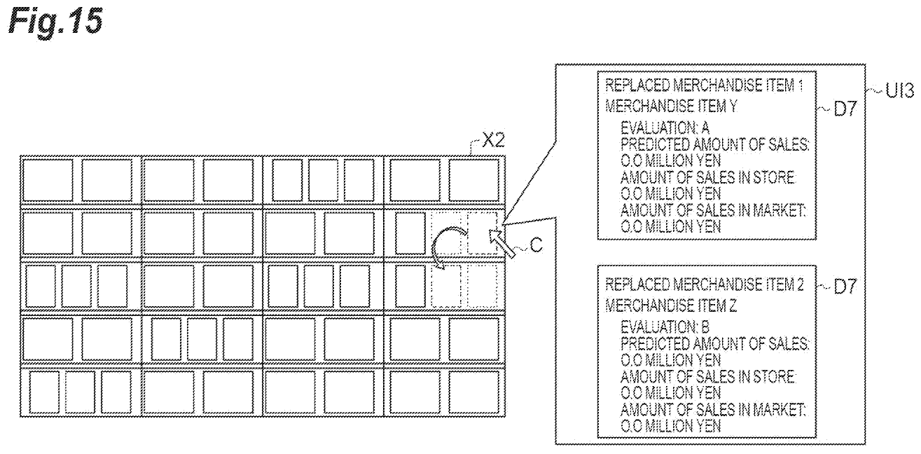

FIG. 15 is a diagram illustrating an example of screen display when the user adds placement correction to the generated planogram information. The display unit 1008 causes the operation/display device 20 to display the generated planogram X2, and causes the operation/display device 20 to display information UI3 on a merchandise item to be replaced in association therewith.

In the example shown in FIG. 15, specifically, the user selects a merchandise item to be replaced by clicking with the cursor C of the operation/display device 20. In this case, as the information UI3, merchandise item information D7 to be replaced and merchandise item information D8 to be replaced are displayed. In a case where the user executes the replacement of the merchandise item selected with the cursor C, for example, a configuration in which an instruction given by double-clicking the cursor C or the like is performed may be used, or a settlement button or the like may be prepared.

Meanwhile, in addition to replacement of a merchandise item, it may be possible to change the planogram conditions themselves and perform the optimization process again. In a case where the user gives an instruction to change the planogram condition themselves, the process returns to the above-described processing performed by the planogram condition/data acquisition unit 1001, and the processing of each unit is executed again.

The output unit 1010 outputs the final planogram information settled by the correction unit 1009, and the grounds information including sales prediction results, merchandise item selection results, grouping results, optimization processing results, and the like.

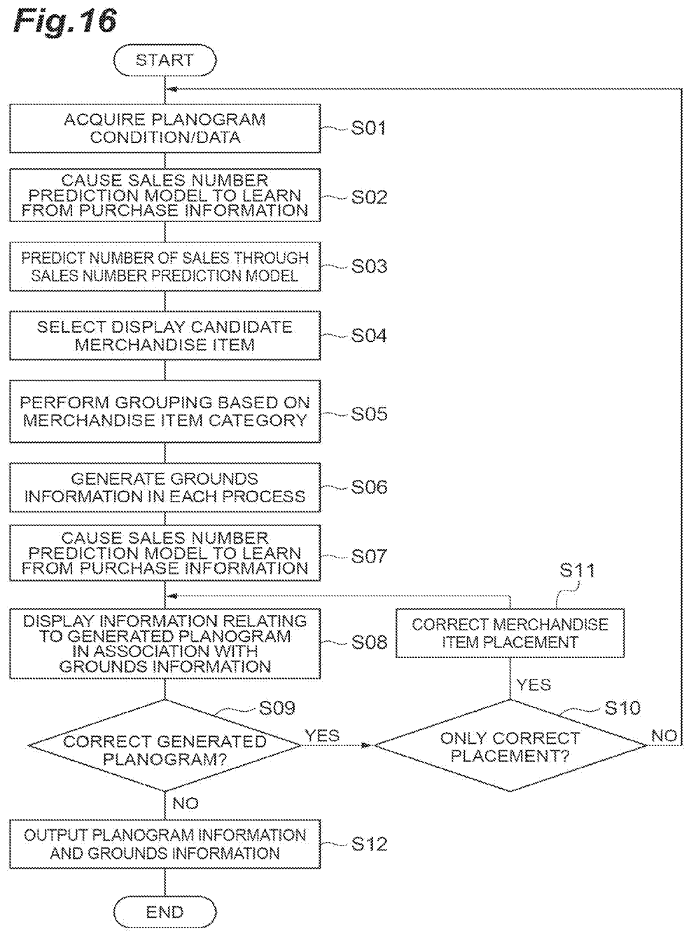

Next, a planogram information generation method in the planogram information generation device 10 will be described with reference to FIG. 16. FIG. 16 is a flowchart illustrating processing content of a planogram information generation method of the present embodiment.

In step S01, the planogram condition/data acquisition unit 1001 acquires planogram conditions and necessary data which are input by the operation/display device 20.

Next, in step S02, the sales number prediction model learning unit 1002 causes a machine learning model for predicting the number of sales to learn from the purchase information acquired in step S01.

Next, in step S03, the sales number prediction model inference unit 1003 predicts the number of future sales of a merchandise item using the machine learning model trained in S02 and the purchase information.

Next, in step S04, the display candidate merchandise item selection unit 1004 selects a display candidate merchandise item to be used in the planogram placement optimization process on the basis of the purchase information.

Next, in step S05, the merchandise item grouping unit 1005 performs grouping of the merchandise item category from the merchandise item information.

Next, in step S06, the planogram merchandise item placement optimization unit 1006 performs final face increase or decrease, selection of added/cut merchandise items, and optimization of merchandise item placement using the planogram conditions and necessary data acquired in step S01, the sales number prediction results in step S03, the display candidate merchandise item selection results in step S04, and the grouping results in step S05, and generates planogram information and information on the predicted amount of sales.

In step S07, the grounds information generation unit 1007 collects processing results of each unit and generates grounds information for describing how the planogram is generated.

In step S08, the display unit 1008 causes the operation/display device 20 to display the results of each process.

In step S09, the correction unit 1009 allows the user to perform correction of merchandise item placement or change of the planogram conditions on the basis of the planogram information displayed in step S08. Here, in a case where the correction is not required (S09-NO), the process proceeds to step S12. On the other hand, in a case where the correction is required, the process proceeds to step S10.

In step S10, in a case where the correction unit 1009 performs only the correction of merchandise item placement (S10-YES), the process proceeds to step S11, the correction of merchandise item placement is performed, and the process of step S08 is executed again. On the other hand, in a case where not only merchandise item placement but also planogram condition change or data change is performed (S10-NO), the process returns to step S01, and the processes of steps S01 to S08 are repeated.

After the planogram is settled (S09-NO), in step S12, the output unit 1010 outputs the settled planogram information and grounds information.

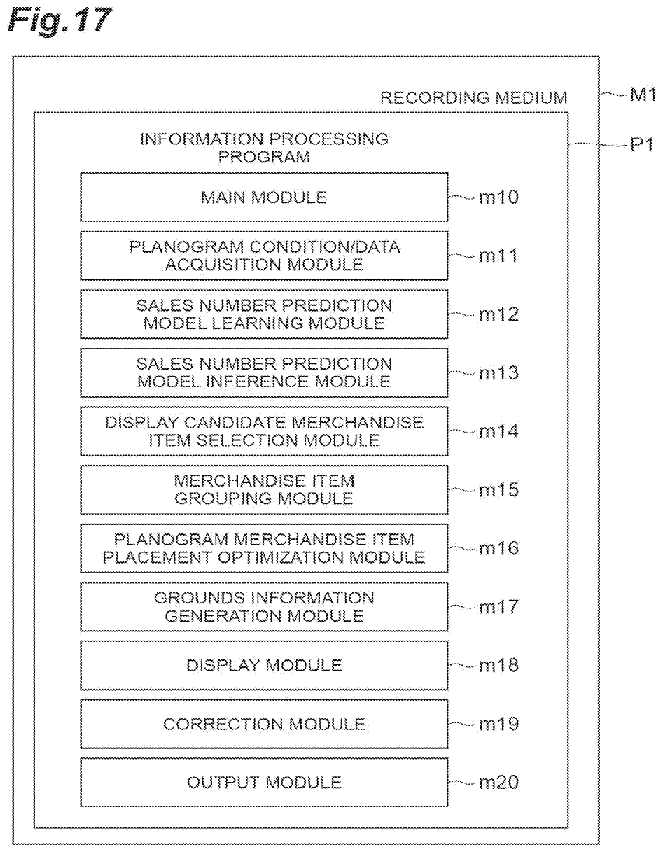

Next, a planogram information generation program for causing a computer to function as the planogram information generation device 10 of the present embodiment will be described. FIG. 17 is a diagram illustrating a configuration of a planogram information generation program P1.

The planogram information generation program P1 is configured to include a main module m10, a planogram condition/data acquisition module 11111, a sales number prediction model learning module m12, a sales number prediction model inference module m13, a display candidate merchandise item selection module m14, a merchandise item grouping module m15, a planogram merchandise item placement optimization module m16, a grounds information generation module m17, a display module m18, correction module m19, and an output module m20 for comprehensively controlling a process of generating planogram information and grounds information in the planogram information generation device 10. The modules m11 to m20 realizes the functions of the planogram condition/data acquisition unit 1001, the sales number prediction model learning unit 1002, the sales number prediction model inference unit 1003, the display candidate merchandise item selection unit 1004, the merchandise item grouping unit 1005, the planogram merchandise item placement optimization unit 1006, the grounds information generation unit 1007, the display unit 1008, the correction unit 1009, and the output unit 1010, respectively, in the planogram information generation device 10. Meanwhile, the planogram information generation program P1 may be transmitted through a transmission medium such as a communication line, or may be stored in a recording medium M1 as shown in FIG. 17.

As described in the above embodiment, the planogram information generation device 10 according to the present embodiment is a planogram information generation device configured to generate planogram information relating to merchandise item placement on a store shelf, the device including: a planogram condition/data acquisition unit 1001 serving as a planogram condition acquisition unit configured to acquire a planogram condition related to a store shelf for which planogram information is to be generated; a sales number prediction model inference unit 1003 serving as a sales number prediction unit configured to predict the number of future sales for each merchandise item on the basis of a machine learning model created on the basis of past purchase information on merchandise items with a possibility of being placed on the store shelf; a display candidate merchandise item selection unit 1004 serving as a display candidate merchandise item selection unit configured to select a merchandise item that is a candidate for display from the merchandise items with the possibility of being placed on the store shelf on the basis of the past purchase information on the merchandise items with the possibility of being placed on the store shelf; a merchandise item grouping unit 1005 serving as a grouping unit configured to perform grouping of merchandise items capable of being placed on the store shelf; and a planogram merchandise item placement optimization unit 1006 serving as a planogram determination unit configured to generate the planogram information so that a predicted amount of sales of the merchandise items placed on the store shelf is maximized on the basis of the planogram condition, a result of sales number prediction for the merchandise items with the possibility of being placed on the store shelf, a result of selection of the display candidate merchandise item, and a result of grouping.

According to the above planogram information generation device, the number of future sales for each merchandise item is predicted on the basis of a machine learning model created on the basis of past purchase information on merchandise items with the possibility of being placed on the store shelf, and then the planogram information is generated so that the predicted amount of sales of the merchandise items placed on the store shelf is maximized on the basis of such sales number prediction as well. Therefore, it is possible to generate planogram information that can be expected to increase sales of the merchandise items placed on the store shelf.

The planogram determination unit can be configured to generate sales information indicating the predicted amount of sales related to the generated planogram information. In this case, the sales information can also be presented to the user of the device. Therefore, the user can ascertain how much the predicted amount of sales is in a case where the generated planogram information is adopted.

The device can be configured to further include a grounds information generation unit 1007 configured to generate grounds information that is information relating to the grounds of generation of the planogram information in the planogram determination unit. In this case, it is also possible to present the grounds information to the user of the device. This makes it possible for the user to ascertain what kind of information the generated planogram information is based on.

The device can be configured to further include a display unit 1008 configured to display the planogram information generated by the planogram determination unit, and a correction unit 1009 configured to correct merchandise item placement included in the planogram information or the planogram condition on the basis of an instruction from a user for the planogram information displayed on the display unit.

In this case, it is possible to correct the planogram information generated by the planogram determination unit in accordance with an instruction from the user based on the information displayed on the display unit 1008, and to generate planogram information that satisfies the user's needs. Meanwhile, the correction unit 1009 is not an essential component.

The device can be configured to further include a sales number prediction model learning unit 1002 serving as a model learning unit configured to create the machine learning model to be used in the sales number prediction unit. In this case, it is possible to create a machine learning model for predicting the number of sales in a host device. Meanwhile, the machine learning model itself may be created by an external device different from the planogram information generation device 10.

The planogram determination unit can be configured to generate the planogram information by solving an optimization problem for maximizing the predicted amount of sales. In this case, since merchandise item placement appropriate for maximizing the predicted amount of sales is automatically specified, it is possible to generate planogram information in which human will or the like is not reflected.

In addition, the prediction model PM1 according to an aspect of the present disclosure may be a trained prediction model for causing a computer to function to predict the number of future sales for each merchandise item on the basis of past purchase information on merchandise items with a possibility of being placed on a store shelf in a planogram information generation device 10 so as to generate planogram information relating to merchandise item placement on the store shelf, the prediction model being generated by executing machine learning using a combination of a feature amount based on information on the number of sales of a specific merchandise item for a specific period in the past and a feature amount based on information on the number of sales for a period following the period as learning data. According to the prediction model PM, in a case where the feature amount based on information on the number of sales for a specific period in the past is used as an input, it is possible to output the feature amount based on information on the number of sales for a period following the period. By performing learning using this learning data, it is possible to improve the accuracy of sales number prediction.

Hereinbefore, the present embodiments have been described in detail, but it is apparent to those skilled in the art that the present embodiments should not be limited to the embodiments described in this specification. The present embodiments can be implemented as modified and changed aspects without departing from the spirit and scope of the present invention, which are determined by the description of the scope of claims. Therefore, the description of this specification is intended for illustrative explanation only, and does not impose any limited interpretation on the present embodiments.

For example, as described above, the planogram information generation device 10 described in the above embodiment can be modified in various ways. Therefore, the function of each unit may be changed in accordance with the change of each unit.

### (Other)

The block diagram used for the description of the above embodiments shows blocks of functions. Those functional blocks (component parts) are implemented by any combination of at least one of hardware and software. Further, a means of implementing each functional block is not particularly limited. Specifically, each functional block may be implemented by one physically or logically combined device or may be implemented by two or more physically or logically separated devices that are directly or indirectly connected (e.g., by using wired or wireless connection etc.). The functional blocks may be implemented by combining software with the above-described one device or the above-described plurality of devices.

The functions include determining, deciding, judging, calculating, computing, processing, deriving, investigating, looking up/searching/inquiring, ascertaining, receiving, transmitting, outputting, accessing, resolving, selecting, choosing, establishing, comparing, assuming, expecting, considering, broadcasting, notifying, communicating, forwarding, configuring, reconfiguring, allocating/mapping, assigning and the like, though not limited thereto. For example, the functional block (component part) that implements the function of transmitting is referred to as a transmitting unit or a transmitter. In any case, a means of implementation is not particularly limited as described above.

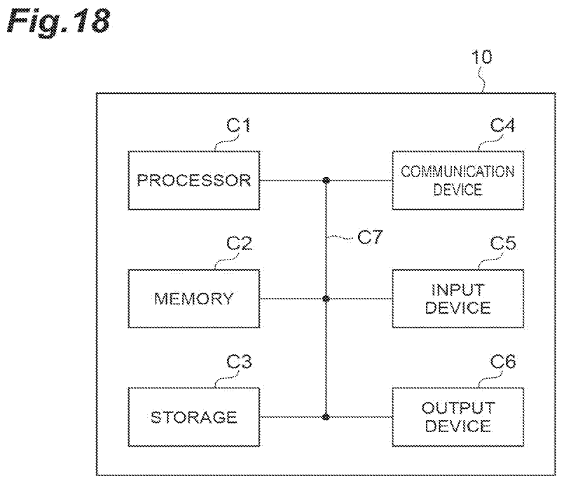

FIG. 18 is a view showing an example of the hardware configuration of the planogram information generation device 10 according to the present embodiment. The planogram information generation device 10 described above may be physically configured as a computer device that includes a processor C1, a memory C2, a storage C3, a communication device C4, an input device C5, an output device C6, a bus C7 and the like.

In the following description, the term “device” may be replaced with a circuit, a device, a unit, or the like. The hardware configuration of the planogram information generation device 10 may be configured to include one or a plurality of the devices shown in FIG. 18. The hardware configuration may also be configured without including some of those devices.

The functions of the planogram information generation device 10 may be implemented by loading predetermined software on hardware such as the processor C1 and the memory C2, so that the processor C1 performs computations to control communications by the communication device C4 and control reading and/or writing of data in the memory C2 and the storage C3.

The processor C1 may, for example, operate an operating system to control the entire computer. The processor C1 may be configured to include a CPU (Central Processing Unit) including an interface with a peripheral device, a control device, an arithmetic device, a register and the like. The processor C1 may also be configured to include a GPU (Graphics Processing Unit). For example, each function section (1001-1010) and the like indicated in FIG. 1 may be implemented by the processor C1.

Further, the processor C1 loads a program (program code), a software module and data from the storage C3 and/or the communication device C4 into the memory C2 and performs various processing according to them. As the program, a program that causes a computer to execute at least some of the operations described in the above embodiments is used. For example, each function section (1001-1010) of the planogram information generation device 10 may be implemented by a control program that is stored in the memory C2 and operates on the processor C1. Although the above-described processing is executed by one processor C1 in the above description, the processing may be executed simultaneously or sequentially by two or more processors C1. The processor C1 may be implemented in one or more chips. Note that the program may be transmitted from a network through a telecommunications line.

The memory C2 is a computer-readable recording medium, and it may be composed of at least one of ROM (Read Only Memory), EPROM (ErasableProgrammable ROM), EEPROM (Electrically ErasableProgrammable ROM), RANI (Random Access Memory) and the like, for example. The memory C2 may be also called a register, a cache, a main memory (main storage device) or the like. The memory C2 can store a program (program code), a software module and the like that can be executed for implementing a planogram information generation method according to one embodiment of the present disclosure.

The storage C3 is a computer-readable recording medium, and it may be composed of at least one of an optical disk such as a CD-ROM (Compact Disk ROM), a hard disk drive, a flexible disk, a magneto-optical disk (e.g., a compact disk, a digital versatile disk, and a Blu-ray (registered trademark) disk), a smart card, a flash memory (e.g., a card, a stick, and a key drive), a floppy (registered trademark) disk, a magnetic strip and the like, for example. The storage C3 may be called an auxiliary storage device. The above-described storage medium may be a database, a server, or another appropriate medium including the memory C2 and/or the storage C3, for example.

The communication device C4 is hardware (a transmitting and receiving device) for performing communication between computers via at a wired and/or a wireless network, and it may also be referred to as a network device, a network controller, a network card, a communication module, or the like.

The input device C5 is an input device (e.g., a keyboard, a mouse, a microphone, a switch, a button, a sensor, etc.) that receives an input from the outside. The output device C6 is an output device (e.g., a display, a speaker, an LED lamp, etc.) that makes output to the outside. Note that the input device C5 and the output device C6 may be integrated (e.g., a touch panel).

In addition, the devices such as the processor C1 and the memory C2 are connected by the bus C7 for communicating information. The bus C7 may be a single bus or may be composed of different buses between different devices.

Further, the planogram information generation device 10 may include hardware such as a microprocessor, a DSP (Digital Signal Processor), an ASIC (Application Specific Integrated Circuit), a PLD (Programmable Logic Device), and an FPGA (Field Programmable Gate Array), and some or all of the functional blocks may be implemented by the above-described hardware components. For example, the processor C1 may be implemented with at least one of these hardware components.

Notification of information may be made by another method, not limited to the aspects/embodiments described in the present disclosure. For example, notification of information may be made by physical layer signaling (e.g., DCI (Downlink Control Information), UCI (Uplink Control Information)), upper layer signaling (e.g., RRC (Radio Resource Control) signaling, MAC (Medium Access Control) signaling, annunciation information (MIB (Master Information Block), SIB (System Information Block))), another signal, or a combination of them. Further, RRC signaling may be called an RRC message, and it may be an RRC Connection Setup message, an RRC Connection Reconfiguration message or the like, for example.

Further, each of the aspects/embodiments described in the present disclosure may be applied to at least one of a system using LTE (Long Tenn Evolution), LTE-A (LTE Advanced), SUPER 3G, IMT-Advanced, 4G (4th generation mobile communication system), 5G (5th generation mobile communication system), FRA (Future Radio Access), NR (new Radio), W-CDMA (registered trademark), GSM (registered trademark), CDMA2000, UMB (Ultra Mobile Broadband), IEEE 802.11 (Wi-Fi), IEEE 802.16 (WiMAX), IEEE 802.20, UWB (Ultra Wide Band), Bluetooth (registered trademark), or another appropriate system and a next generation system extended on the basis of these systems. Further, a plurality of systems may be combined (e.g., a combination of at least one of LTE and LTE-A, and 5G) for application.

The procedure, the sequence, the flowchart and the like in each of the aspects/embodiments described in the present disclosure may be in a different order unless inconsistency arises. For example, for the method described in the present disclosure, elements of various steps are described in an exemplified order, and it is not limited to the specific order described above.

The information or the like can be output from an upper layer (or lower layer) to a lower layer (or upper layer). It may be input and output through a plurality of network nodes.

Input/output information or the like may be stored in a specific location (e.g., memory) or managed in a management table. Further, input/output information or the like can be overwritten or updated, or additional data can be written. Output information or the like may be deleted. Input information or the like may be transmitted to another device.

The determination may be made by a value represented by one bit (0 or 1), by a truth-value (Boolean: true or false), or by numerical comparison (e.g., comparison with a specified value).

Each of the aspects/embodiments described in the present disclosure may be used alone, may be used in combination, or may be used by being switched according to the execution. Further, a notification of specified information (e.g., a notification of “being X”) is not limited to be made explicitly, and it may be made implicitly (e.g., a notification of the specified information is not made).

Although the present disclosure is described in detail above, it is apparent to those skilled in the art that the present disclosure is not restricted to the embodiments described in this disclosure. The present disclosure can be implemented as a modified and changed form without deviating from the spirit and scope of the present disclosure defined by the appended claims. Accordingly, the description of the present disclosure is given merely by way of illustration and does not have any restrictive meaning to the present disclosure.

Software may be called any of software, firmware, middleware, microcode, hardware description language or another name, and it should be interpreted widely so as to mean an instruction, an instruction set, a code, a code segment, a program code, a program, a sub-program, a software module, an application, a software application, a software package, a routine, a sub-routine, an object, an executable file, a thread of execution, a procedure, a function and the like.

Further, software, instructions and the like may be transmitted and received via a transmission medium. For example, when software is transmitted from a website, a server or another remote source using at least one of wired technology (a coaxial cable, an optical fiber cable, a twisted pair and a digital subscriber line (DSL) etc.) and wireless technology (infrared rays, microwave etc.), at least one of those wired technology and wireless technology are included in the definition of the transmission medium.

The information, signals and the like described in the present disclosure may be represented by any of various different technologies. For example, data, an instruction, a command, information, a signal, a bit, a symbol, a chip and the like that can be referred to in the above description may be represented by a voltage, a current, an electromagnetic wave, a magnetic field or a magnetic particle, an optical field or a photon, or an arbitrary combination of them.

Note that the term described in the present disclosure and the term needed to understand the present disclosure may be replaced by a term having the same or similar meaning. For example, at least one of a channel and a symbol may be a signal (signaling). Further, a signal may be a message. Furthermore, a component carrier (CC) may be called a cell, a frequency carrier, or the like.

The terms “system” and “network” used in the present disclosure are used to be compatible with each other.

Further, information, parameters and the like described in the present disclosure may be represented by an absolute value, a relative value to a specified value, or corresponding different information. For example, radio resources may be indicated by an index.

The names used for the above-described parameters are not definitive in any way. Further, mathematical expressions and the like using those parameters are different from those explicitly disclosed in the present disclosure in some cases. Because various channels and information elements (e.g., TPC etc.) can be identified by every appropriate names, various names assigned to such various channels and information elements are not definitive in any way.

Note that the term “determining” and “determining” used in the present disclosure includes a variety of operations. For example, “determining” and “determining” can include regarding the act of judging, calculating, computing, processing, deriving, investigating, looking up/searching/inquiring (e.g., looking up in a table, a database or another data structure), ascertaining or the like as being “determined” and “determined”. Further, “determining” and “determining” can include regarding the act of receiving (e.g., receiving information), transmitting (e.g., transmitting information), inputting, outputting, accessing (e.g., accessing data in a memory) or the like as being “determined” and “determined”. Further, “determining” and “determining” can include regarding the act of resolving, selecting, choosing, establishing, comparing or the like as being “determined” and “determined”. In other words, “determining” and “determining” can include regarding a certain operation as being “determined” and “determined”. Further, “determining (determining)” may be replaced with “assuming”, “expecting”, “considering” and the like.

The term “connected”, “coupled” or every transformation of this term means every direct or indirect connection or coupling between two or more elements, and it includes the case where there are one or more intermediate elements between two elements that are “connected” or “coupled” to each other. The coupling or connection between elements may be physical, logical, or a combination of them. For example, “connect” may be replaced with “access”. When used in the present disclosure, it is considered that two elements are “connected” or “coupled” to each other by using at least one of one or more electric wires, cables, and printed electric connections and, as several non-definitive and non-comprehensive examples, by using electromagnetic energy such as electromagnetic energy having a wavelength of a radio frequency region, a microwave region and an optical (both visible and invisible) region.

The description “on the basis of” used in the present disclosure does not mean “only on the basis of” unless otherwise noted. In other words, the description “on the basis of” means both of “only on the basis of” and “at least on the basis of”.

As long as “include”, “including” and transformation of them are used in the present disclosure, those terms are intended to be comprehensive like the term “comprising”. Further, the term “or” used in the present disclosure is intended not to be exclusive OR.

In the present disclosure, when articles, such as “a”, “an”, and “the” in English, for example, are added by translation, the present disclosure may include that nouns following such articles are plural.

In the present disclosure, the term “A and B are different” may mean that “A and B are different from each other”. Note that this term may mean that “A and B are different from C”. The terms such as “separated” and “coupled” may be also interpreted in the same manner.

### REFERENCE SIGNS LIST

1 Planogram information generation system
10 Planogram information generation device
20 Operation/display device
30 Planogram condition storage unit
40 Learning/inference result storage unit
50 Merchandise item information storage unit
60 Display candidate merchandise item storage unit
70 Grouping result storage unit
80 Planogram information storage unit
90 Purchase information storage unit
100 Optimization result storage unit
1001 Planogram condition/data acquisition unit
1002 Sales number prediction model learning unit
1003 Sales number prediction model inference unit
1004 Display candidate merchandise item selection unit
1005 Merchandise item grouping unit
1006 Planogram merchandise item placement optimization unit
1007 Grounds information generation unit
1008 Display unit
1009 Correction unit
1010 Output unit

1. A planogram information generation device configured to generate planogram information relating to merchandise item placement on a store shelf, the device comprising:
a planogram condition acquisition unit configured to acquire a planogram condition related to a store shelf for which the planogram information is to be generated;
a sales number prediction unit configured to predict the number of future sales for each merchandise item on the basis of a machine learning model created on the basis of past purchase information on merchandise items with a possibility of being placed on the store shelf,
a display candidate merchandise item selection unit configured to select a merchandise item that is a candidate for display from the merchandise items with the possibility of being placed on the store shelf on the basis of the past purchase information on the merchandise items with the possibility of being placed on the store shelf;
a grouping unit configured to perform grouping of merchandise items capable of being placed on the store shelf; and
a planogram determination unit configured to generate the planogram information so that a predicted amount of sales of the merchandise items placed on the store shelf is maximized on the basis of the planogram condition, a result of sales number prediction for the merchandise items with the possibility of being placed on the store shelf, a result of selection of the display candidate merchandise item, and a result of grouping.

2. The planogram information generation device according to claim 1, wherein the planogram determination unit generates sales information indicating the predicted amount of sales related to the generated planogram information.

3. The planogram information generation device according to claim 1, further comprising a grounds information generation unit configured to generate grounds information that is information relating to the grounds of generation of the planogram information in the planogram determination unit.

4. The planogram information generation device according to claim 1 3 further comprising:
a display unit configured to display the planogram information generated by the planogram determination unit; and
a correction unit configured to correct merchandise item placement included in the planogram information or the planogram condition on the basis of an instruction from a user for the planogram information displayed on the display unit.

5. The planogram information generation device according to claim 1, further comprising a model learning unit configured to create the machine learning model to be used in the sales number prediction unit.

6. The planogram information generation device according to claim 1, wherein the planogram determination unit generates the planogram information by solving an optimization problem for maximizing the predicted amount of sales.

7. A trained prediction model for causing a computer to function to predict the number of future sales for each merchandise item on the basis of past purchase information on merchandise items with a possibility of being placed on a store shelf in a planogram information generation device so as to generate planogram information relating to merchandise item placement on the store shelf,
the prediction model being generated by executing machine learning using a combination of a feature amount based on information on the number of sales of a specific merchandise item for a specific period in the past and a feature amount based on information on the number of sales for a period following the period as learning data.

8. The planogram information generation device according to claim 2, further comprising a grounds information generation unit configured to generate grounds information that is information relating to the grounds of generation of the planogram information in the planogram determination unit.

9. The planogram information generation device according to claim 2 further comprising:
a display unit configured to display the planogram information generated by the planogram determination unit; and
a correction unit configured to correct merchandise item placement included in the planogram information or the planogram condition on the basis of an instruction from a user for the planogram information displayed on the display unit.

10. The planogram information generation device according to claim 2, further comprising a model learning unit configured to create the machine learning model to be used in the sales number prediction unit.

11. The planogram information generation device according to claim 2, wherein the planogram determination unit generates the planogram information by solving an optimization problem for maximizing the predicted amount of sales.

12. The planogram information generation device according to claim 3 further comprising:
a display unit configured to display the planogram information generated by the planogram determination unit; and
a correction unit configured to correct merchandise item placement included in the planogram information or the planogram condition on the basis of an instruction from a user for the planogram information displayed on the display unit.

13. The planogram information generation device according to claim 3, further comprising a model learning unit configured to create the machine learning model to be used in the sales number prediction unit.

14. The planogram information generation device according to claim 3, wherein the planogram determination unit generates the planogram information by solving an optimization problem for maximizing the predicted amount of sales.

15. The planogram information generation device according to claim 4 further comprising a model learning unit configured to create the machine learning model to be used in the sales number prediction unit.

16. The planogram information generation device according to claim 4, wherein the planogram determination unit generates the planogram information by solving an optimization problem for maximizing the predicted amount of sales.
